(19) United States
(12) Patent Application Publication
(10) Pub. No.: US 2015/0050508 A1
(43) Pub. Date: Feb. 19, 2015

(54) Printable Coating Systems For Flexible Magnetic Sheets

(71) Applicant: Magnum Magnetics Corporation, Marietta, OH (US)

(72) Inventors: Joseph B. Stout, Williamstown, WV (US); Charles Furr, Summerfield, OH (US)

(21) Appl. No.: 14/460,158

(22) Filed: Aug. 14, 2014

Related U.S. Application Data
(60) Provisional application No. 61/865,956, filed on Aug. 14, 2013.

(51) Int. Cl. C09D 125/08; C09D 133/00

(52) U.S. Cl. CPC C09D 125/08; C09D 133/00
USPC 428/522; 524/556; 427/521

(57) ABSTRACT

Material compositions and methods for the production of printable flexible magnetic sheets having printable surfaces configured to accelerate the drying of print ink after application of the ink to the coated surface.

### CROSS-REFERENCE TO RELATED APPLICATION AND CLAIM OF PRIORITY

This application claims priority under 35 U.S.C. §119(e) from provisional application Ser. No. 61/865,956 filed Aug. 14, 2013, which is incorporated by reference herein in its entirety.

### BACKGROUND OF THE INVENTION

This invention relates to providing a system for improved printable materials capable of magnetically adhering to a magnetically-compatible surface. More particularly, this system provides printable coatings and methods of producing printable magnetic sheet materials having printable surfaces configured to accelerate the drying of flexographic and lithographic inks.

The speed of high-volume flexographic and lithographic printing production is often limited by the curing/drying times of the applied inks. If an applied ink dries too slowly, the ink may rub-off the print surface during the subsequent finishing steps or during transport. A related concern is set-off of the applied inks. Set-off is the tendency of ink to transfer from a freshly printed surface to another surface when the two are in contact. Set-off is an unwanted behavior that is influenced by the properties of both the printable surface and the ink.

A common conventional solution to overcome these problems is to extend the drying time by reducing the speed of the press; however, this option is often undesirable due to inherent losses in overall production efficiency. Altering process variables, such as temperature, ink composition, etc., may not be practical or produce satisfactory results in all instances. Having more efficient options for reliably reducing the drying/setting time of inks, to reduce rub-off/smudging, would be of great benefit in the printing industry.

### OBJECTS OF THE INVENTION

An object and feature of the present invention is to provide a system overcoming the above-mentioned problems. A further object of the present invention is to provide such a system including aqueous-based, solvent-free coatings for use in gravure and flexographic printing that are configured to provide strong, adherent printable surfaces on flexible magnetizable sheet substrates with performance properties substantially similar to conventional paper substrates.

It is still another object of the present invention to provide such a system of water-based and organic solvent-free coatings that are IR (Infrared) curable to produce such printable surfaces on such flexible magnetizable sheet substrates.

It is a further object of this invention to provide processes of making and using the foregoing compositions. A further object of the present invention is to provide such a system that is efficient, inexpensive, and handy. Other objects and features of this invention will become apparent with reference to the following descriptions.

### SUMMARY OF THE INVENTION

In accordance with one aspect of the invention, a printable magnetic sheet is provided, having a magnetizable layer containing at least one magnetizable component; and a printable coating layer forming a printable surface of said magnetizable layer on which printing ink is applied, said printing coating layer containing an acrylic resin, and at least one of a printing ink absorption promoting agent, a surface solvent evaporation promoting agent, a pH-value buffering agent, and a printing ink oxidative polymerization promoting agent.

In accordance with another aspect of the invention, a method of applying a printable coating in liquid form to a magnetizable layer containing at least one magnetizable component is provided, the method including: corona treating said magnetizable layer to 40-50 dyne; applying the printable coating to the corona-treated magnetizable layer using at least two stands of a flexographic press, at least one of the stands including an Allison doctor blade; and drying the printable coating using infrared heat.

### BRIEF DESCRIPTION OF THE DRAWINGS

FIG. 1 shows a perspective view, illustrating a printable magnetic sheet comprising a printable surface, according to a preferred embodiment of the present invention.

FIG. 2 shows a sectional view, through the section 2-2 of FIG. 1, according to the preferred embodiment of FIG. 1.

### DETAILED DESCRIPTION OF THE INVENTION

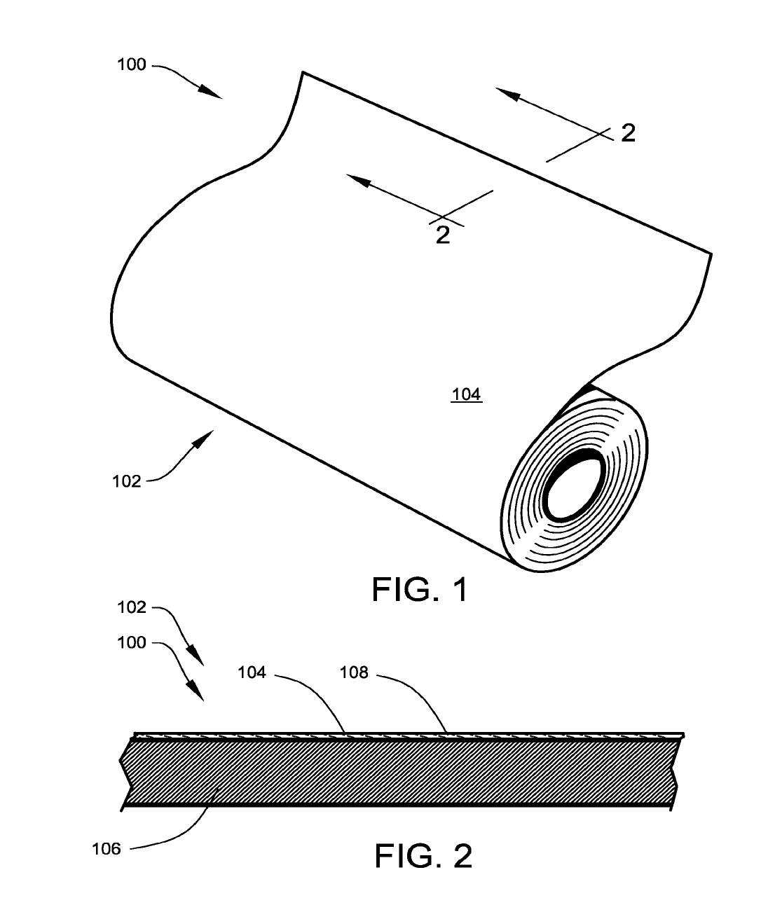

FIG. 1 shows a perspective view, illustrating printable magnetic sheet 102 comprising printable surface 104, according to an embodiment of the present invention. FIG. 2 shows a sectional view, through the section 2-2 of FIG. 1, according to the preferred embodiment of FIG. 1.

Some preferred embodiments of printable magnetic sheet system 100, as described herein, preferably include compositions of printable coatings and printable magnetic sheets utilizing such coatings. In addition, Applicant's printable magnetic sheet system 100 includes preferred methods of producing such printable magnetic sheet materials. The preferred material embodiments of printable magnetic sheet system 100 comprise printable surfaces 104 configured to accelerate the drying of print inks.

Referring to FIG. 1 and FIG. 2, Applicant has developed a useful printable magnetic sheet 102 for use with conventional lithographic, flexographic, gravure, offset, and Ultra-Violet (UV) printing, for example, using a Heidelberg Speedmaster offset press, or similar printing equipment.

Printable magnetic sheet 102 preferably comprises multiple material layers, as best shown in FIG. 2. A preferred arrangement of printable magnetic sheet 102 comprises magnetizable layer 106 and printable coating layer 108, as shown. Magnetizable layer 106 contains at least one magnetizable component and printable coating layer 108 is structured and arranged to form printable surfaces 104. Magnetizable layer 106 and printable coating layer 108 are preferably bound together in such manner as to form an indivisible sheet structure.

Magnetizable layer 106 preferably comprises at least one flexible magnetizable material, preferably allowing magnetization of printable magnetic sheet 102 by an external magnetic field (such material preferably remaining magnetized after the external field is removed). A preferred magnetizable composition comprises a homogenous mixture of ferrous particles and at least one binding material. Such binding material preferably imparts to printable magnetic sheet 102 at least the properties of shape retention and flexibility.

The ferrous particles preferably comprise ferrite particles, preferably strontium ferrite particles (SrFe12019), alternately preferably barium ferrite powder (BaFe12019). Preferred ferrous particles comprise approximate diameters less than about 20 nanometers each. A preferred source of ferrite powder is Hoosier Magnetics, Inc. located in Ogdensburg, N.Y. (product number HM 410). Alternately, a high-quality ferrite powder is obtained in a recycled-powder form from TDK Corporation. Upon reading this specification, those skilled in the art will now appreciate that, under appropriate circumstances, considering such issues as cost, available materials, etc., other than ferrous particles exhibiting magnetic qualities, such as, for example, Heusler alloys, lanthanide elements, as of yet formulated ferromagnetic compositions (which can be magnetized by an external magnetic field and which remain magnetized after the external field is removed), etc., may suffice.

In magnetizable layer 106, the magnetizable material is preferably suspended in at least one polymeric matrix. The polymeric matrix preferably comprises at least one polymeric binder material. Preferred polymeric binders are structured and arranged to bind the magnetizable material within magnetizable layer 106.

Preferred binding materials include synthetic polymers, with thermoplastic binders being preferred. Magnetizable layer 106 may be formed by passing a granulated homogenous mixture of pulverized ceramic ferrite and polymer through a calendering nip where it is preferably formed into a sheet having a predetermined thickness and width. Alternately preferably, magnetizable layer 106 may be formed by an extrusion process followed by calendering.

One preferred thickness of magnetizable layer 106, provided as a non-limiting example, is about 0.017 inch. Preferred physical properties of Applicant's preferred magnet compositions include a shore hardness of about D60, a specific gravity of about 3.5, material shrinkage of about <1.5% @158° F. (70° C.), 7 days, tensile strength of about 700 pounds per square inch (49 kg/cm2), and a flexibility permitting the material to be coiled to about a ½″ (12.7 mm) radius without cracking at 68′ F. (20° C.). When magnetized, magnetizable layer 106 preferably comprises a magnetic energy of at least 1.0 MGOe (Megagauss Oersted), more preferably about 1.7 MGOe.

Where such magnetizable materials generally darken the coloring of printable magnetic sheet 102, to a point where most printing or marking is made indistinguishable, printable coating layer 108 preferably provides a lightened surface coloring, preferably enabling such printing or such marking to be clearly distinguishable on the outer sheet surface.

### Description Outlining Preferred Physical and Chemical Properties of Inventors' Preferred Printable Coatings Used to Form Printable Coating Layer

TABLE 1
PRINTABLE COATING PHYSICAL
AND CHEMICAL PROPERTIES

| | | |
|---|---|---|
| | Physical State: | Liquid |
| | Boiling Point (@760 mm Hg): | About 200-230° F. |
| | Evaporation Rate: | (<1) dependant on |
| | (butyl acetate = 1) | temperature and humidity. |
| 3) | Freezing point: | About 32° F |
| | pH: | About8.5-9.5 |
| | Solubility in Water: | Dispersible |
| | Solids, % by wt: | About 70-75% |
| | Density (lb/gal): | About 12.0-13.0 |
| | Volatile Organic Compounds | <0.12% X. |
| | (VOC's, | |

Table 2 contains descriptions outlining additional preferred compositions and material characteristics of applicant's preferred printable coatings used to form printable coating layer 108.

TABLE 2

The printable coating is preferably applied to magnetizable
layer 106 in a liquid state.
Printable coating layer 108 is preferably applied to
magnetizable layer 106 using at least one coating
process, more preferably, at least one printing process,
more preferably, at least one flexographic-type printing
process.
Preferred coating formulations are preferably water based
with water being between about 10-35% by weight (prior to
curing).
The coating composition preferably comprises a high pigment
content ratio of 60-75% by wt. prior to curing.
The printable coating comprises at least one
substantially opaque pigment (preferably functioning as an
opacifier).
The preferred pigment color is white.
A preferred white pigment is Titanium dioxide (TiO2).
Alternately preferably, white pigment in the form of
Zinc oxide (ZnO)may be used; however, the use of Zinc
oxide is less preferred.
The printable coatings are preferably formulated using
acrylic resin with Styrene-Acrylic resin being most
preferred.
Acrylic resin is preferably 5-15% by wt. (prior to
curing).

In general, lithographic/flexographic inks dry via combinations of surface absorption, solvent evaporation, and/or oxidative polymerization. Printable coating layer 108 is preferably designed to accelerate the drying rate of printing inks/varnishes applied to printable surface 104.

Printable coating layer 108 is preferably designed to accelerate the drying rate of lithographic/flexographic inks using at least one of the following methods:

a) improved surface absorption characteristics;

b) improved solvent evaporation;

c) adding at least one buffering agent to control pH-values at printable surface 104; and

d) adding at least one drying agent.

In one preferred printable coating composition of the present system, surface absorption characteristics are preferably engineered to provide absorptive porosity at the coating surface, thus promoting the permeation of air and rapid ink setting (preferably implemented via the addition of a fine carbonate, such as calcium carbonate, or alternately preferably, at least one starch). It is noted that calcium carbonate may also act as a buffering agent to maintain the pH of the surface in the preferred range of about 8.5-9.5.

In another preferred printable coating composition of the present system, at least one catalyzer (i.e., drying accelerator agent) is incorporated in the printable coating formulation to promoting oxidative polymerization of the printing ink. Preferred drying accelerator agents include transition metal complexes or transition metal salts, wherein the metal ion of the transition metal complex or salt is preferably selected from the group consisting of Ti, V, Cr, Ni, Mn, Fe, Co (preferred), Ce, Cu, or a mixture thereof. Alternate preferred drying accelerator agents promote polymerization via other chemical oxidation processes, such as, for example, adapted to water-based flexographic/gravure ink compositions.

Upon reading this specification, those with ordinary skill in the art will now appreciate that, under appropriate circumstances, considering such issues as press configuration, user preferences, ink selection, cost, performance requirements, available materials, technological advances, etc., other additives such as, for example, surfactants, waxes, rheology modifying agents, binders, colorants, alcohols, emulsifiers, plasticizers, stabilizers, etc., may suffice.

### Cured Properties of the Printable Coating Composition

Applicant's preferred printable coating is preferably configured to form printable coating layers 108 with the following engineered performance characteristics:
1) Compatible with conventional flexographic-type printing processes
2) Capable of achieving ink drying times substantially equivalent to conventional paper substrates
3) Capable of producing a gloss surface
4) Capable of achieving opacity values when cured
5) Capable of producing a minimum L value of 90 in L, a, b spectrometer readings
6) Capable of being applied as a thin coating (preferably between about 0.0008″ and 0.001″ thick)

### Preferred Example Methods of Applying the Printable Coating to the Magnetizable Layer

### Coating Process 1:

1) Preferably, the surface of magnetizable layer 106 is first corona treated to 40-50 dyne prior to top coating for proper adhesion of the printable coating to magnetizable layer 106.

2) The printable coating is preferably applied using two stands of a flexographic press.
a) A 13bcm ceramic anilox roll is preferably used for first stand—preferably comprising a 30-degree hex channel pattern.
b) A 21bcm ceramic anilox roll is preferably used for second stand—preferably comprising 30 degree hex channel pattern.

3) A line speed of between about 60-70 feet per minute (fpm) is preferred

4) Allison doctor blades are preferably used in both stands, 30″ long× 13/16′ wide×0.010″ thick angled—QRH standard

5) The printable coating is preferably dried with IR heat.

6) Magnetizable layer 106 is optionally back coated. Back coating preferably functions as a physical barrier to prevent migration of the inherently dark ferrite powder from the binder of the magnet portion to the surfaces to which the magnets are adhered. Back coating also assists in printing and handling processes by reducing blocking issues that are sometimes experienced on long rolls of plain magnet or thick stacks of cut sheets.

### Coating Process 2:

1) Preferably, the surface of Magnetizable layer 106 is first corona treated to 40-50 dyne prior to top coating for proper adhesion of the printable coating to magnetizable layer 106.

2) The printable coating is preferably applied using three stands of a flexographic press.

3) Preferred Anilox Cell Patterns:

| | | | |
|---|---|---|---|
| Station #1 | 150 LPI | Q311 | 13.0 Vol |
| Station #2 | 80/30 LPI | Q | 25.0 Vol |
| Station #3 | 350 LPI | Q322 | 4.6 Vol |

4) Preferred Doctor blade thickness:
About 0.008 inch 5) Preferred Plate/Blanket Material:
85-95% screen (for best solid coverage [opacity] screened material will create more surface area for the plate to pick up coating from anilox). This also creates relief within the plate to avoid “squeegee effects” of ink to the sides/trailing edge.

6) Preferred tint sleeve:
Durometer 50 Shore A

7) Gloss Readings (60 degree)
a) Unprinted—Cross & Machine direction=6 Gloss Units (GU)
b) Printed and UV coated—Cross 36-38 GU, Machine 65-69 GU

### Experimental Testing

Extensive experimental testing was performed by Applicant during the development process. Testing of Applicant's sheet coating was performed on sheets having a physical size of about 19 inches by about 25¼ inches. Each sheet possessed a measured weight of about 1 pound. The sheets were supplied unmagnetized and included a back-coating. The overall sheet thickness tested was about 0.018 inch (comprising about 0.017 inch of magnetic layer and about 0.001 inch of coating layer). A skid test of material (to determine set-off) consisted of 1200 sheets. A print run of about 1200 sheets at a rate of around 5800 sheets per hour was tested using a Heidelberg Speedmaster offset press.

### Test Results

Applicant's printable coating was found to be fully compatible with conventional flexographic-type printing processes. Printable surfaces 104 exhibited ink drying times substantially equivalent to conventional paper substrates. No significant blocking or adherence was observed in a skid of printed product allowed to sit for about 24 hours. The spectrometer measured L value of the produce was in the range of 90, within the targeted L, a, b readings for white coating of 90 as a minimum.

Although Applicant has described Applicant's preferred embodiments of this invention, it will be understood that the broadest scope of this invention includes modifications such as diverse shapes, sizes, and materials. Such scope is limited only by the below claims as read in connection with the above specification. Further, many other advantages of Applicant's invention will be apparent to those skilled in the art from the above descriptions and the below claims.

What is claimed is:

1. A printable magnetic sheet, comprising:
a magnetizable layer containing at least one magnetizable component; and
a printable coating layer forming a printable surface of said magnetizable layer on which printing ink is applied, said printing coating layer containing an acrylic resin, and at least one of a printing ink absorption promoting agent, a surface solvent evaporation promoting agent, a pH-value buffering agent, and a printing ink oxidative polymerization promoting agent.

2. A printable magnetic sheet as set forth in claim 1, wherein said printing ink absorption promoting agent comprises a fine carbonate.

3. A printable magnetic sheet as set forth in claim 2, wherein said fine carbonate comprises calcium carbonate.

4. A printable magnetic sheet as set forth in claim 1, wherein said printing ink absorption promoting agent comprises a starch.

5. A printable magnetic sheet as set forth in claim 1, wherein said printing ink printing ink oxidative polymerization promoting agent comprises a transition metal complex or salt.

6. A printable magnetic sheet as set forth in claim 1, wherein said transition metal complex or salt comprises a metal ion selected from the group consisting of Ti, V, Cr, Ni, Mn, Fe, Co, Ce, Cu, or a mixture thereof.

7. A printable magnetic sheet as set forth in claim 6, wherein said transition metal complex or salt comprises a Co metal ion.

8. A printable magnetic sheet as set forth in claim 2, wherein said buffering agent comprises calcium carbonate.

9. A printable magnetic sheet as set forth in claim 1, wherein said printable coating layer further comprises at least one opaque pigment.

10. A printable magnetic sheet as set forth in claim 9, wherein said at least one opaque pigment has a content ratio of 60-75% by weight prior to curing of said coating.

11. A printable magnetic sheet as set forth in claim 9, wherein said at least one opaque pigment comprises titanium dioxide.

12. A printable magnetic sheet as set forth in claim 1, wherein said acrylic resin comprises styrene-acrylic resin.

13. A printable magnetic sheet as set forth in claim 1, wherein said acrylic resin comprises 5-15% by weight of said coating prior to curing.

14. A printable coating adapted to be applied to a magnetizable layer containing at least one magnetizable component, said printable coating being an aqueous-based composition containing an acrylic resin, and at least one of a printing ink absorption promoting agent, a surface solvent evaporation promoting agent, a pH-value buffering agent, and a printing ink oxidative polymerization promoting agent.

15. A method of applying a printable coating as set forth in claim 14 to a magnetizable layer containing at least one magnetizable component, said method comprising:
corona treating said magnetizable layer to 40-50 dyne;
applying said printable coating to said corona-treated magnetizable layer using at least two stands of a flexographic press, at least one of said stands including an Allison doctor blade; and
drying said printable coating using infrared heat.

16. The method of claim 15, wherein a 13bcm ceramic anilox roll comprising a 30-degree hex channel pattern is used for said first stand, and a 21bcm ceramic anilox roll comprising a 30 degree hex channel pattern is used for said second stand.

17. The method of claim 15, wherein flexographic press has a line speed of 60-70 feet per minute.

18. The method of claim 15, wherein said printable coating is applied to said corona-treated magnetizable layer using three stands of a flexographic press.

19. The method of claim 18, wherein said flexographic press stands comprise anilox rolls.

20. A method of applying a printable coating in liquid form to a magnetizable layer containing at least one magnetizable component, said method comprising:
corona treating said magnetizable layer to 40-50 dyne;
applying said printable coating to said corona-treated magnetizable layer using at least two stands of a flexographic press, at least one of said stands including an Allison doctor blade; and
drying said printable coating using infrared heat.
